(19) United States
(12) Patent Application Publication
(10) Pub. No.: US 2003/0030323 A1
(43) Pub. Date: Feb. 13, 2003

(54) Turning sensor for improved ATC performance

(76) Inventors: Gary Ford, St. Joseph, MI (US); Paul Johnston, Troy, MI (US); Yngve Naerheim, Thousand Oaks, CA (US); Shan Shih, Troy, MI (US); Marco Bassi, Novate Milanese (IT); Mark A. Schakel, Fletcher, NC (US); Michael E. Johnson, Rochester, MI (US); Mark E. Malinowski, Farmington Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/923,376

(22) Filed: Aug. 7, 2001

(51) Int. Cl. B60T 8/60

(52) U.S. Cl. 303/146

(57) ABSTRACT

A method and system for detecting wheel slippage uses a turn sensor to detect a vehicle turning radius in order to predict the difference in wheel speed between wheels on the outside of the turning radius and wheels on the inside of the turning radius. The turn sensor detects the turning radius of the vehicle and signals a controller. The controller utilizes the signal from the turn sensor to predict a difference in wheel speeds between the wheel to the inside of the turn and the wheel to the outside of the turn. One of the driven axles includes wheel speed sensors mounted at opposite ends of the axle. The controller receives signals from each of the wheel speed sensors to determine an actual differential wheel speed. The predicted speed differential is compared to the actual speed differential and any difference between the two indicates wheel is slippage.

### BACKGROUND OF THE INVENTION

This application discloses a method and system for sensing wheel slip of a motor vehicle.

Automatic Traction Control (ATC) is used to reduce wheel slipping in order that the motor vehicle can be better controlled. The ATC system reduces wheel slippage by reducing torque transmitted to the slipping wheel. Typically, the ATC system will include a wheel speed sensor at each driven wheel to detect wheel slippage. The number of wheel sensors required for some applications such as heavy trucks having multiple axles may become prohibitively expensive. Typically, sensing the wheel speed of each wheel on one side of the motor vehicle and comparing that wheel speed to the wheel speed of other wheels on the same side of the motor vehicle is used to detect wheel slippage. A wheel rotating at a different speed than other wheels on the same side of the motor vehicle will indicate that the wheel is slipping. The torque to that wheel can then be controlled to reduce or eliminate wheel slippage.

The system requires a speed sensor at each wheel to detect wheel speed. The use of multiple wheel speed sensors is costly for motor vehicles having multiple axles.

A system utilizing fewer wheel sensors to detect wheel slippage is desirable to reduce the total cost and complexity of the system.

### SUMMARY OF THE INVENTION

The invention is a method and system for detecting wheel slippage by predicting a differential wheel speed and comparing the differential wheel speed to an actual wheel speed differential.

The system utilizes a turn sensor to detect the vehicle turning radius and signal a controller. The controller utilizes the signal from the turn sensor to predict a difference in wheel speeds between wheels to the inside of the turn and wheels to the outside of the turn. One of the driven axles includes wheel sensors mounted at opposite ends of the axle. The wheel sensors send a signal to the controller indicating actual wheel speed. The controller utilizes the signals from the wheel sensors to determine an actual speed differential. The predicted speed differential is compared to the actual speed differential and any significant difference between the predicted and actual wheel speed will indicate that one of the wheels are slipping. Utilizing the turn sensor to predict the speed differential between the wheel to the inside of the turn and the wheel to the outside of the turn provides for the use of only two wheel sensors mounted at opposite ends of the driven axle.

The invention provides for a system that utilizes fewer wheel sensors such that cost and complexity are minimized.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of the subject invention in a motor vehicle having tandem axles.

### DETAILED DESCRIPTION OF THE PREFERRED EMBODIMENT

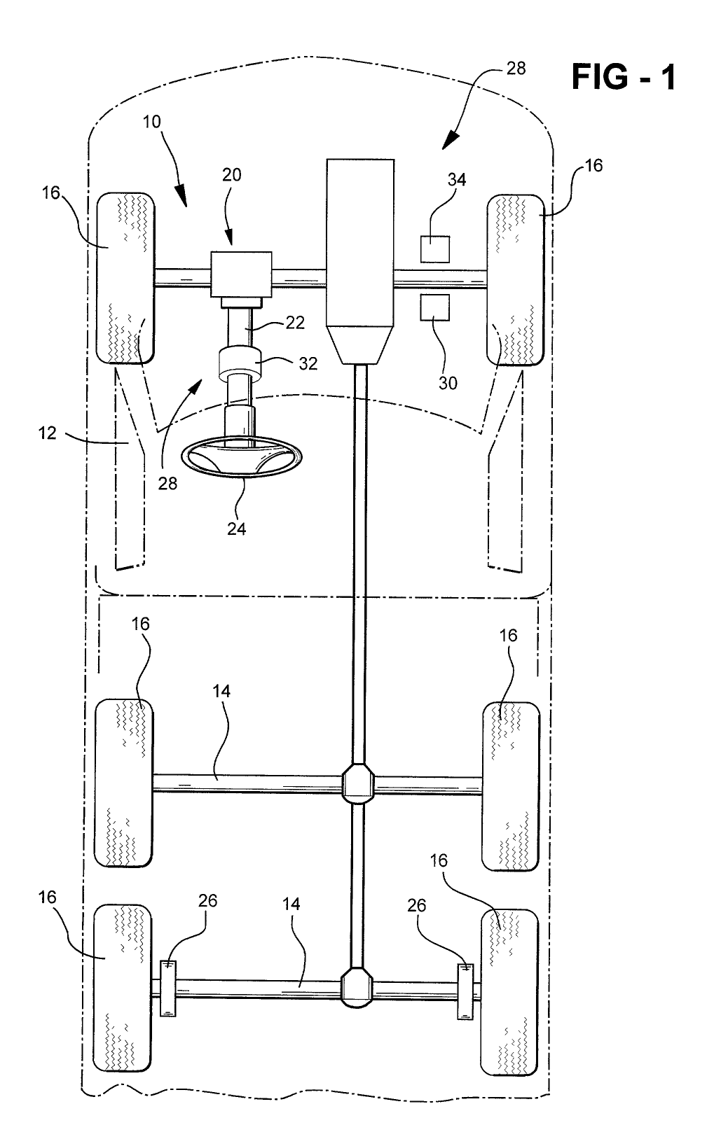

Referring to the Figures, wherein like numerals indicate like or corresponding parts throughout the several views, the invention is a system for detecting wheel slip in a vehicle having automatic traction control (ATC) and is generally indicated at 10. FIG. 1 is a schematic representation of the system 10 installed into a vehicle 12. Preferably the vehicle 12 includes at least one drive axle 14 having wheels 16 at opposite ends. The vehicle 12 shown schematically in FIG. 1 includes a tandem axle assembly 18 with two driven axles 14. The vehicle 12 includes a steering assembly 20 having a steering column 22 and a steering wheel 24. An ATC system 25 of the vehicle is shown schematically which may be of any type known in the art is incorporated into a differential 27 of the vehicle. The ATC system 25 limits the torque to a slipping wheel to provide for better control of the vehicle 12.

The system 10 includes wheel sensors 26 to detect actual wheel speed and are mounted at opposite ends of one axle 14 in the tandem axle assembly 18, a turn sensor 32, which may also be of any type known in the art, to detect a turn of the vehicle 12 is shown schematically, and a controller 30 to receives signals from both the wheel sensors 26 and the turn sensor 28.

The turn sensor 32 detects the turning radius of the vehicle 12 and signals the controller 30. The turn sensor 32 may be mounted to the steering assembly 20 to detect rotation of the steering wheel 24 and steering column 22 and provide a signal representing rotation of the steering column to the controller 30. The controller 30 correlates rotation of the steering column 22 to determine the turning radius of the motor vehicle. As appreciated, when a vehicle 12 turns, the wheel to the outside of the turn must rotate faster than the wheel to the inside of the turn because the wheel to the outside of the turn has a longer distance to travel. The turn sensor 32 detects the turning radius which determines how much faster the outside wheel must rotate with respect to the inside wheel. The turn sensor 32 may also be a yaw sensor 34 mounted anywhere within the vehicle 12. Also, both the rotation sensor 32 and the yaw sensor 34 maybe used simultaneously to detect the turning radius of the vehicle 12. It should be appreciated that any sensor for detecting the direction of the vehicle known by those knowledgeable the art may be used and is within the contemplation of this invention.

The controller 30 receives signals from the turn sensor(s) 32 and/or 34 to determine a predicted wheel speed differential based on the radius of turn of the vehicle 12. Simultaneously, the controller receives signals from the wheel speed sensors 26 to determine an actual wheel speed differential. The predicted wheel speed differential is compared to the actual wheel speed differential to predict wheel slippage. This allows the use of a single wheel speed sensor 26 on each side of the vehicle 12, thereby eliminating the need for multiple wheel speed sensors on each side of the vehicle 12. The predicted wheel speed differential obtained from the signal transmitted by the turn sensor in effect replaces the multiple wheel sensors 12 required to detect wheel slippage in prior art systems. The controller 30 compares the predicted wheel speed differential with the actual wheel speed differential to detect slippage of any of the driven wheels.

The method by which the controller determines that the wheels are slipping follows by first providing the turn sensor to detect the turning radius of the vehicle 12. Second a predicted wheel speed differential is determined utilizing the signal from the turn sensor 28. A signal from the wheel sensors 26 mounted to opposite ends of one of the axles 14 in the tandem axle assembly 18 and is sent to the controller 30. The controller 30 utilizes the signal from the wheel sensors 26 to determine the actual wheel speed differential during a turn. The predicted wheel speed differential is compared to the actual wheel speed differential. A predetermined difference is needed to indicate that one of the wheels 16 are slipping. Specifically, if the predicted speed differential is greater than the actual speed differential, the wheel to the outside of the turning radius is slipping. Conversely, if the actual speed differential is greater than the predicted speed differential the wheel to the inside of the turning radius is slipping. Further, if the turn sensor signals the controller that the vehicle 12 is not turning, the predicted speed differential between wheels is zero. The system will then indicate wheel slippage if the actual speed differential is above a predetermined amount. The predetermined amount is selected to provide for misreading, errors, tolerances, etc. and to provide for a sufficient level of slippage prior to actuation of the ATC systems 25. Once the determination has been made that one of the wheels 16 is slipping, the controller 30 will signal the ATC system to reduce torque to the slipping wheel. A worker in this art would understand how to provide the appropriate controls, both hardware and software to accomplish the above functions. A worker knowledgeable in the art would also know how to determine the turning radius and associated predicted speed differentials.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A method of detecting wheel slip for a vehicle, said method comprising the steps of;
(a) detecting a turn of the motor vehicle;
(b) predicting a wheel speed differential between an inside wheel and an outside wheel based on the detected turn of the vehicle;
(c) detecting an actual speed of the inside wheel and the outside wheel to obtain an actual wheel speed differential;
(d) comparing the predicted wheel speed differential with the actual wheel speed differential to determine if any of the wheels are slipping.

2. The method of claim 1, wherein said comparing step is further defined by determining that the inside wheel is slipping if the predicted wheel speed differential is greater than the actual wheel speed differential.

3. The method of claim 1, wherein said comparing step is further defined by determining that the outside wheel is slipping if the predicted speed differential is less than the actual wheel speed differential.

4. The method of claim 1, wherein said sensor to detect a turn of the vehicle is further defined as a sensor mounted to the steering wheel of the vehicle to detected rotation of the steering wheel, and thereby the corresponding turning radius of the vehicle.

5. The method of claim 1, wherein said sensor to detect a turn of the vehicle is further defined as a yaw sensor to detect the yaw of the vehicle, and thereby the corresponding turning radius of the vehicle.

6. A system for detecting wheel slip of a vehicle having multiple drive axles and automatic traction control, said system comprising;
a wheel disposed on each end of a drive axle;
a wheel speed sensor mounted to detect wheel speed of said wheels on said drive axle;
a turn sensor to detect a turning radius of the vehicle;
a controller to receive and interpret signals from said wheel speed sensor and said turn sensor to predict wheel slippage.

7. A system as in claim 6, further including a steering assembly for steering the vehicle, wherein said turn sensor is mounted to detect movement of said steering assembly, and said controller correlates movement of said steering assembly with said turning radius of the vehicle.

8. A system as in claim 7, further including a yaw sensor to detect said turning radius of the vehicle.

9. A system as in claim 6, wherein said sensor for detecting said turning radius of the vehicle is a yaw sensor mounted to the vehicle.

10. A system as in claim 6, wherein there are driven axles arranged in tandem and said wheel sensors are mounted to only one of said driven axles arranged in tandem.
